(19) United States
(12) Patent Application Publication
(10) Pub. No.: US 2016/0157231 A1
(43) Pub. Date: Jun. 2, 2016

(54) Method and Network Node for Providing Radio Resources for Radio Communication in a Cellular Network

(71) Applicant: TELEFONAKTIEBOLAGET L M ERICSSON (PUBL), Stockholm (SE)

(72) Inventors: Robert Baldemair, Solna (SE); Jung-Fu Cheng, Fremont, CA (US); Sorour Falahati, Stockholm (SE); Mattias Frenne, Uppsala (SE); Havish Koorapaty, Saratoga, CA (US); Daniel Larsson, Stockholm (SE)

(21) Appl. No.: 14/901,142

(22) PCT Filed: Jun. 28, 2013
(86) PCT No.: PCT/SE2013/050827

§ 371 Date: Dec. 28, 2015

(51) Int. Cl. H04W 72/04; H04L 5/00

(52) U.S. Cl. CPC H04W 72/0453; H04L 5/0064

(57) ABSTRACT

A method and network node (600) for providing radio resources in resource blocks in frequency domain in a first system bandwidth (BW1) and in a second system bandwidth (BW2) different than the first system bandwidth and overlapping the first system bandwidth, wherein the first and second system bandwidths have a common frequency centre. The network node (600) applies a number of resource blocks in the first system bandwidth,and appliesan even or odd number of resource blocks in the second system bandwidth when the number of resource blocks in the first system bandwidth is even or odd, respectively. Thereby, an even or odd number of resource blocks is applied in both system bandwidth (BW1, BW2) such that successive resource blocks in frequency are aligned across the first and second system bandwidths (BW1, BW2) which enables full utilization of the potential capacity. The network node further signals an indication of the applied number of resource blocks in at least one of the first and second system bandwidths to at least one mobile terminal (604, 606).

### TECHNICAL FIELD

The present disclosure relates generally to a method and a network node of a cellular network for radio communication, for providing radio resources in frequency domain in a first system bandwidth and in a second system bandwidth different than the first system bandwidth and overlapping the first system bandwidth. The radio resources can be used for radio communication with mobile terminals in the cellular network.

### BACKGROUND

In recent years, different types of cellular networks for radio communication have been developed to provide radio access for various mobile terminals in different areas. The cellular networks are constantly improved to provide better coverage and capacity to meet the demands from subscribers using services and increasingly advanced terminals, e.g. smartphones and tablets, which may require considerable amounts of bandwidth and resources for data transport over a radio interface in the networks. Therefore, an operator of such a network constantly strives to improve capacity in the network by efficient usage of radio resources within a certain limited bandwidth which the operator has attained permission to use for radio communications in the network.

In this disclosure, the terms “mobile terminal” and “radio node” will be used, the latter representing a node of a cellular network that can communicate uplink and downlink radio signals with a mobile terminal. Another commonly used term in this field is User Equipment, UE, which is equivalent to mobile terminal in the context of this disclosure. The radio node in this disclosure may also be referred to as a base station, NodeB, e-NodeB, eNB, base transceiver station, relay, etc., depending on the terminology used. The term “network node” is also used which may be any node in the cellular network, such as a radio node, a network managing node, a radio resource managing node, a radio node controller, and so forth. Further, a mobile terminal is typically held and operated by a person, but it may also be stationary device and operating automatically, e.g. for executing instructions or sending measurements or other observations to the network, as automatically performed by itself.

As indicated above, during periods of high traffic load, capacity can be increased in a cellular network by allocating radio resources to different mobile terminals in an efficient manner such that as little radio resources as possible are wasted by not being useable, given the limited total amount of available radio resources within a frequency spectrum allocated to the cellular network. The radio resources are typically defined in both the frequency domain and the time domain and the following definitions are used in the standard of Long Term Evolution, LTE, developed by the Third Generation Partnership Project, 3GPP. In the time domain, the radio resources are divided into subframes of 1 ms, each comprising two slots of 0.5 ms. In the frequency domain, the radio resources are divided into subcarriers each having a frequency range of 15 kHz.

Furthermore, allocation of radio resources for transmissions in either downlink or uplink is commonly made in terms of resource blocks where a resource block extends over one slot in the time domain and over 12 contiguous subcarriers in the frequency domain, thus covering a frequency range of 12×15=180 kHz. This disclosure is concerned with the utilization of bandwidth in the frequency domain and allocation of radio resources will be discussed in terms of resource blocks. The total bandwidth used for transmissions in a cellular network is thus divided into contiguous resource blocks which are numbered across the bandwidth range used. The total number of resource blocks that can be allocated for various transmissions in a cell or coverage area is dependent on the extent of the total bandwidth used in a cellular network which is called the “system bandwidth”.

Downlink transmissions of data in a cell or coverage area are dynamically scheduled for different receiving mobile terminals and a radio node serving the cell or coverage area transmits control information indicating which terminals the data will be transmitted to and in which resource blocks, the latter being addressed in the control information by using the above resource block numbering. It is also possible to address groups of resource blocks, e.g. with 1, 2, 3 or 4 resource blocks in each group, which enables use of fewer bits in the addressing of allocated radio resources when there are two or more resource blocks in a resource block group.

In LTE, a set of 6 different system bandwidths has been defined, namely 1.4, 3, 5, 10, 15 and 20 MHz, to specify requirements for both mobile terminals and radio nodes for radio communication on resource blocks according to any of these system bandwidths. It was assumed that these 6 predefined system bandwidths would match spectrum allocations for most network operators known at the time. Each of these 6 system bandwidths can encompass a certain number of contiguous resource blocks, which are shown in the table 1 below. Thus, any mobile terminal configured for LTE is capable of using any of these ranges of resource blocks depending on the network's allocated frequency spectrum.

TABLE 1

| System Bandwidth | Number of Resource Blocks |
|---|---|
| 1.4 | 6 |
| 3 | 15 |
| 5 | 25 |
| 10 | 50 |
| 15 | 75 |
| 20 | 100 |

If a network operator wants to configure and apply radio resources to make efficient use of a newly granted frequency spectrum different than the above 6 predefined system bandwidths, the number of resource blocks that can be used will also differ from the numbers shown in table 1, column on the right. For example, an operator may have used a system bandwidth of 5 MHz with 25 resource blocks and is at some point granted a wider frequency spectrum allowing a system bandwidth of 7 MHz which can obviously provide increased capacity, e.g. by enabling a greater number of contiguous resource blocks across the 7 MHz bandwidth. However, the new system bandwidth of 7 MHz is not predefined in table 1 which means that mobile terminals configured to communicate only according to the predefined system bandwidths in table 1 will not be able to communicate according to the new system bandwidth of 7 MHz. This may be the case for “old” terminals, commonly referred to as “legacy terminals”, and certain low-cost terminals designed for limited price and low power consumption. However, a more advanced terminal may be configured to use the 7 MHz bandwidth and can therefore be served on that system bandwidth.

In order to take advantage of the better capacity of an expanded system bandwidth, e.g. as of the above example of expanding the system bandwidth from 5 MHz to 7 MHz, it is proposed that two different configurations of system bandwidth can be applied simultaneously in a cell or coverage area for serving different mobile terminals depending on their capabilities. This is schematically illustrated in FIG. 1 where a radio node 100 covering a cell or coverage area 100a is serving a set of legacy and low-cost terminals 102 using a first bandwidth configuration BW1, and at the same time is also serving another set of more advanced terminals 104 using a second bandwidth configuration BW2 greater than BW1.

With reference to the above example, the 5 MHz system bandwidth may be deployed to serve legacy and low-cost terminals and the 7 MHz system bandwidth may be deployed to serve the more advanced terminals in the network. The 5 MHz system bandwidth is configured with 25 resource blocks in accordance with table 1 while the 7 MHz system bandwidth can be configured with a greater number of resource blocks, not defined for legacy LTE, to provide greater capacity.

However, when deploying two different system bandwidth configurations with different numbers of resource blocks, the allocation of resource blocks for transmissions in the two system bandwidths must be made so as to avoid transmission collisions across the respective system bandwidths. It is a problem that during periods of high traffic load some parts of the total system bandwidth may be left unused to avoid collisions and the potential capacity can therefore not be fully utilized, which will be explained in more detail below.

### SUMMARY

It is an object of embodiments described herein to address at least some of the problems and issues outlined above. It is possible to achieve this object and others by using a network node, a mobile terminal and methods therein as defined in the attached independent claims.

According to one aspect, a method is performed by a network node of a cellular network for radio communication, for providing radio resources in resource blocks in frequency domain in a first system bandwidth and in a second system bandwidth different than the first system bandwidth and overlapping the first system bandwidth. The first and second system bandwidths have a common frequency centre, and the radio resources are useful for radio communication with mobile terminals in a cell or coverage area of the cellular network.

In this method, the network node applies a number of resource blocks in the first system bandwidth. The network node further applies an even number of resource blocks in the second system bandwidth when the number of resource blocks in the first system bandwidth is even, and applies an odd number of resource blocks in the second system bandwidth when the number of resource blocks in the first system bandwidth is odd. The network node also signals an indication of the applied number of resource blocks in at least one of the first and second system bandwidths to at least one mobile terminal in the cell or coverage area.

According to another aspect, a network node of a cellular network for radio communication is configured to provide radio resources in resource blocks in frequency domain in a first system bandwidth and in a second system bandwidth different than the first system bandwidth and overlapping the first system bandwidth. The first and second system bandwidths have a common frequency centre, and the radio resources are useful for radio communication with mobile terminals in a cell or coverage area of the cellular network.

The network node comprises a logic unit adapted to apply a number of resource blocks in the first system bandwidth. The logic unit is further adapted to apply an even number of resource blocks in the second system bandwidth when the number of resource blocks in the first system bandwidth is even, and to apply an odd number of resource blocks in the second system bandwidth when the number of resource blocks in the first system bandwidth is odd. The network node also comprises a signalling unit adapted to signal an indication of the applied number of resource blocks in at least one of the first and second system bandwidths to at least one mobile terminal in the cell or coverage area.

According to another aspect, a method is performed by a mobile terminal connected to a serving radio node of a cellular network employing a first system bandwidth and a second system bandwidth for radio communication. The second system bandwidth is different than the first system bandwidth and overlaps the first system bandwidth. The first and second system bandwidths also have a common frequency centre. The method is performed by the mobile terminal for communicating over radio resources in resource blocks in frequency domain in the second system bandwidth.

In this method, the mobile terminal receives from the serving radio node a signalled difference between the number of resource blocks in the second system bandwidth and the number of resource blocks in the first system bandwidth. The signalled difference is received as an even delta value such that both numbers of resource blocks in the first and second system bandwidths are even or odd. The mobile terminal then determines the number of resource blocks in the second system bandwidth based on the number of resource blocks in the first system bandwidth and the signalled difference.

According to another aspect, a mobile terminal is adapted to be connected to a serving radio node of a cellular network employing a first system bandwidth and a second system bandwidth for radio communication. The second system bandwidth is different than the first system bandwidth and overlaps the first system bandwidth, and the first and second system bandwidths having a common frequency centre. The mobile terminal is configured to communicate over radio resources in resource blocks in frequency domain in the second system bandwidth.

The mobile terminal comprises a receiving unit which is adapted to receive from the serving radio node a signalled difference between the number of resource blocks in the second system bandwidth and the number of resource blocks in the first system bandwidth, and to receive the signalled difference as an even delta value such that both numbers of resource blocks in the first and second system bandwidths are even or odd. The mobile terminal also comprises a determining unit which is adapted to determine the number of resource blocks in the second system bandwidth based on the number of resource blocks in the first system bandwidth and the signalled difference.

By applying an odd or even number of resource blocks in both of the two system bandwidths and using a common frequency centre, the resource blocks becomes aligned across the two system bandwidths so that the resource block borders in one system bandwidth coincide with the resource block borders in the other system bandwidth. It is then an advantage that usage of a resource block in one bandwidth configuration makes just one corresponding resource block unusable in the other bandwidth configuration to avoid collision, thanks to the alignment of resource blocks across the bandwidths. Thereby it is possible to utilize the full potential capacity without unusable parts of the available frequency spectrum.

The above network node, mobile terminal and methods may be configured and implemented according to different optional embodiments to accomplish further features and benefits, to be described below.

### BRIEF DESCRIPTION OF DRAWINGS

The solution will now be described in more detail by means of exemplary embodiments and with reference to the accompanying drawings, in which:

FIG. 1 is a communication scenario illustrating that two different bandwidth configurations are used in the same cell, according to the prior art.

FIG. 2 is a schematic diagram illustrating two bandwidth configurations with misaligned resource blocks, resulting in unusable capacity.

FIG. 3 is a schematic diagram illustrating two bandwidth configurations with an even number of aligned resource blocks, according to some possible embodiments.

FIG. 4 is a schematic diagram illustrating two bandwidth configurations with an odd number of aligned resource blocks, according to further possible embodiments.

FIG. 5 is a flow chart illustrating a procedure in a network node, according to further possible embodiments.

FIG. 6 is a block diagram illustrating a network node in more detail, according to further possible embodiments.

FIG. 7 is a flow chart illustrating a procedure in a mobile terminal, according to further possible embodiments.

FIG. 8 is a block diagram illustrating a mobile terminal in more detail, according to further possible embodiments.

### DETAILED DESCRIPTION

In this solution it is recognized that when deploying two different configurations of system bandwidth with different numbers of resource blocks for radio communication in a cellular network, the resource blocks in one system bandwidth may not be aligned in frequency with the resource blocks in the other system bandwidth. As a result, when some resource blocks in one system bandwidth are scheduled and used for radio communication, certain resource blocks in the other system bandwidth will only partly coincide with the ones used, due to the misalignment, and will therefore be unserviceable, i.e. not possible to use at the same time without collision. Some parts of the total available bandwidth are therefore not useable and the potential capacity cannot be fully realized.

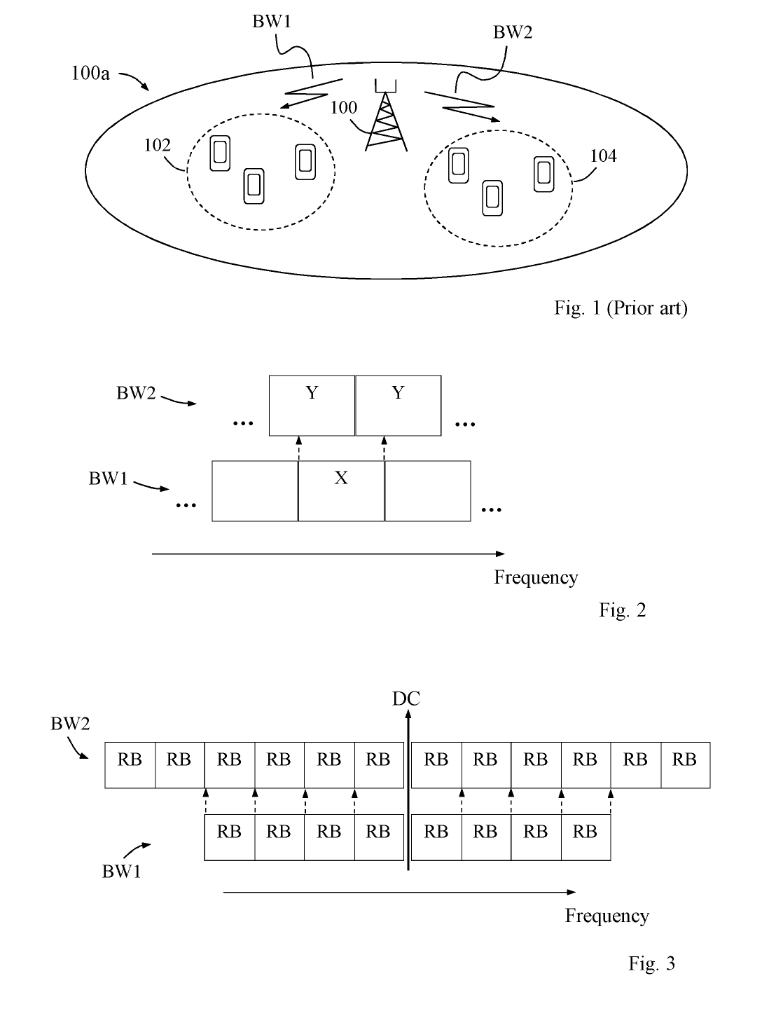

An example of how the above problem may occur is illustrated in FIG. 2 where resource blocks configured for two overlapping bandwidth configurations BW1 and BW2 are misaligned as indicated by the dashed arrows. A currently allocated and used resource block “X” of the first bandwidth configuration BW1 thus partly overlaps with two resource blocks “Y” of the second bandwidth configuration BW2. The transmission in resource block X thus hits both resource blocks Y such that neither of resource blocks Y can be scheduled and used for transmission without colliding with the transmission in resource block X. In other words, usage of one resource block in one bandwidth configuration makes two resource blocks unusable in the other bandwidth configuration due to the misalignment of resource blocks across the bandwidths and potential capacity is thereby wasted.

In this solution, the problem of unusable parts of the allocated frequency spectrum is addressed by applying resource blocks in the two system bandwidths such that the resource blocks are aligned across the two system bandwidths, in other words the resource block borders in one system bandwidth coincide with the resource block borders in the other system bandwidth. As a result, usage of one resource block in one bandwidth configuration makes just one resource block unusable in the other bandwidth configuration, and not two resource blocks as in FIG. 2, thanks to the alignment of resource blocks across the bandwidths such that it is possible to utilize the full potential capacity. It is thus possible to avoid that fractions of the allocated frequency spectrum will be left that cannot be scheduled and used for transmission due to collision across the system bandwidths, which will be described and explained in more detail below.

Although the following examples will be discussed in terms of two simultaneously used system bandwidths for simplicity, the solution is not limited to using two system bandwidths but may be applied for any number of multiple simultaneously used system bandwidths. It is assumed that when two configurations of system bandwidth with different numbers of resource blocks are used for radio communication in a cellular network, the system bandwidths are placed within a frequency spectrum allocated for the network such that they have a common frequency centre, e.g. in the middle of the allocated frequency spectrum, and the system bandwidths are thus overlapping one another. The common frequency centre may be a Direct Current, DC, subcarrier which is commonly applied when using multiple configurations of system bandwidth in a cellular network.

The above-described alignment of resource blocks across two simultaneously used system bandwidths can be achieved by applying an even number of resource blocks in both system bandwidths or by applying an odd number of resource blocks in both system bandwidths. In this solution it is recognized that the above-described misalignment of resource blocks occurs when one system bandwidth has an even number of resource blocks and the other system bandwidth has an odd number of resource blocks.

FIG. 3 illustrates an example of the case when an even number of resource blocks is applied in two system bandwidths BW1 and BW2 which are symmetrically distributed in frequency domain around a common frequency centre, in this case a DC subcarrier. Thus in this example, BW1 has 8 resource blocks and BW2 has 12 resource blocks. Since these are even numbers, the resource block borders of BW1 coincide in frequency with the resource block borders of BW2, as indicated by dashed arrows, and the resource blocks are thus aligned across BW1 and BW2. The common frequency centre occurs between two contiguous resource blocks in either system bandwidth BW1, BW2 due to the even numbers of resource blocks.

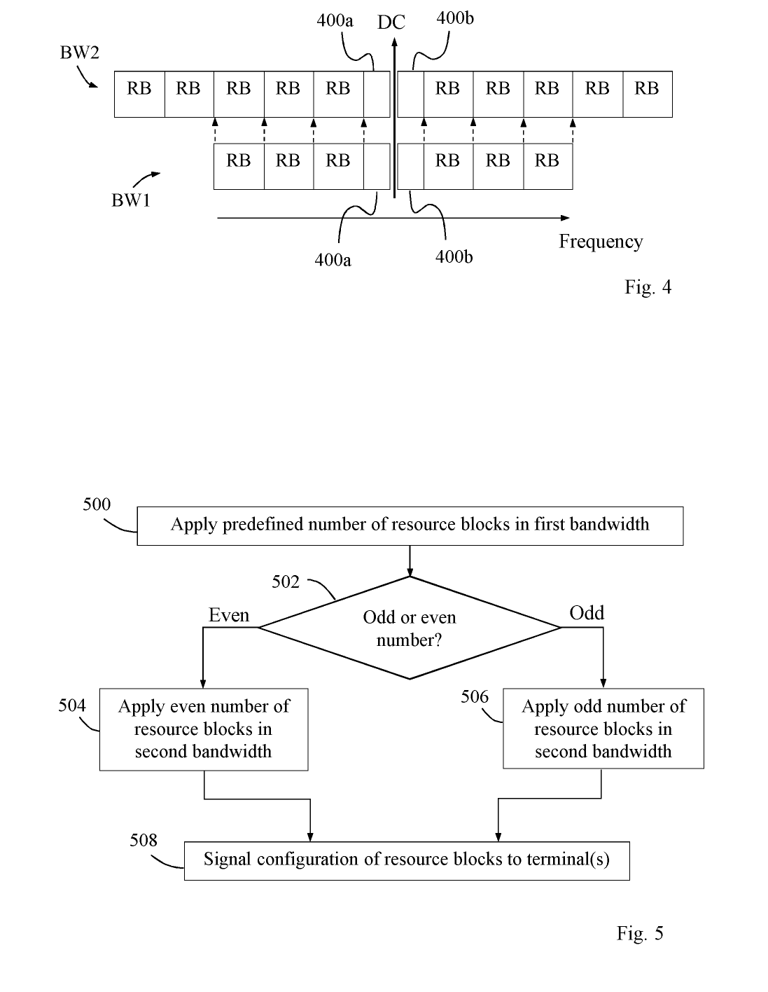

FIG. 4 illustrates an example of the other case when an odd number of resource blocks is applied in both system bandwidths BW1 and BW2. Thus in this example, BW1 has 7 resource blocks and BW2 has 11 resource blocks. Since these are odd numbers, the resource block borders of BW1 coincide in frequency with the resource block borders of BW2, again indicated by dashed arrows, and the resource blocks are thus aligned across BW1 and BW2 in this case too. The common frequency centre occurs in the middle of a centre resource block in the middle of either system bandwidth BW1, BW2 due to the odd numbers of resource blocks, thus splitting the centre resource block into two halves 400a and 400b.

As a result, if one of the resource blocks in either system bandwidth in FIG. 3 or FIG. 4 is scheduled for transmission, only one corresponding resource block in the other system bandwidth will be unserviceable while any of the other resource blocks can be scheduled without collision.

The solution outlined above and in the following examples may be implemented by functionality in a network node of a cellular network for radio communication. The term “network node” is consistently used throughout this disclosure although other similar and fitting terms could be used as well. In practice, the network node described here may be implemented in a radio node, a network managing node, a radio resource managing node, a radio node controller, and so forth. A radio node may in turn be a base station, NodeB, e-NodeB, eNB, base transceiver station, relay, etc., depending on the terminology used. However, it should be noted that the network node is not limited to the above examples.

An example of how the network node may operate when employing the solution will now be described with reference to the flow chart in FIG. 5, illustrating actions performed by the network node to provide radio resources in resource blocks in frequency domain in a first system bandwidth and in a second system bandwidth different than the first system bandwidth and overlapping the first system bandwidth. It is assumed that the first and second system bandwidths have a common frequency centre, basically as described above, and that the radio resources are useful for radio communication with mobile terminals present in a cell or coverage area of the cellular network.

In a first shown action 500, the network node applies a number of resource blocks in the first system bandwidth. The number of resource blocks in the first system bandwidth may be selected out of a set of predefined numbers of resource blocks valid for different predefined system bandwidths. The first system bandwidth thus has a size, i.e. width, and a number of contiguous resource blocks that may correspond to the size and number of resource blocks of one of the predefined system bandwidths, e.g. one of those represented in the above table 1.

For example, the widest possible system bandwidth in the set of predefined system bandwidths that is within a frequency spectrum allocated for the cellular network may be selected as the first system bandwidth. In that case, the second system bandwidth may be wider than the first system bandwidth, which is consequently between the first system bandwidth and the next wider system bandwidth, if any, in the set of predefined system bandwidths.

If the allocated frequency spectrum is e.g. 7 MHz, the widest possible system bandwidth in the set of predefined system bandwidths in Table 1 that is within the 7 MHz frequency spectrum is 5 MHz which may thus be selected as the first system bandwidth. Further, if the second system bandwidth is wider than the first system bandwidth, e.g. close to 7 MHz to exploit the potential capacity of the allocated frequency spectrum, the second system bandwidth is between the first system bandwidth of 5 MHz and the next wider system bandwidth of 10 MHz according to Table 1. In that case, the number of resource blocks in the first system bandwidth of 5 MHz is 25 according to Table 1, and an odd number of resource blocks would therefore be applied for the second system bandwidth of 7 MHz which will be an odd number between 25 (for 5 MHz) and 50 (for 10 MHz) according to Table 1.

Another action 502 illustrates that the network node acts depending on whether the applied number of resource blocks in the first system bandwidth is odd or even. When the number of resource blocks in the first system bandwidth is even, the network node applies an even number of resource blocks for radio communication in the second system bandwidth, in an action 504. Thereby, overlapping resource blocks in the first and second system bandwidths will be aligned in the frequency domain. Otherwise, i.e. when the number of resource blocks in the first system bandwidth is odd, the network node applies an odd number of resource blocks for radio communication in the second system bandwidth, in an action 506. As a result, overlapping resource blocks in the first and second system bandwidths will be aligned in the frequency domain in this case as well.

Finally, an action 508 illustrates that the network node signals an indication of the applied number of resource blocks in at least one of the first and second system bandwidths to at least one mobile terminal in the cell or coverage area. In different possible embodiments, the signalled indication may comprise the applied number of resource blocks in at least one of the first and second system bandwidths, that is the applied number of resource blocks is signalled explicitly. Alternatively, the signalled indication may comprise identities of the resource blocks in at least one of the first and second system bandwidths, e.g. according to a fitting numbering scheme such as resource blocks “X-Y” or similar. The signalled indication may further comprise a difference in number of resource blocks in the first and second system bandwidths. The indication of the number of resource blocks may be signalled to multiple mobile terminals in broadcasted system information, or to an individual mobile terminal in a dedicated message.

The above-described actions may be performed by the network node in conjunction with further possible embodiments. In a possible embodiment, resource blocks in the first system bandwidth may be scheduled to serve a first type of mobile terminals supporting the first system bandwidth but not the second system bandwidth. The resource blocks in the first system bandwidth may also be scheduled to serve a second type of mobile terminals supporting both the first system bandwidth and the second system bandwidth. Further, the resource blocks in the second system bandwidth may be scheduled to serve the second type of mobile terminals but not the first type of mobile terminals. In this case, the resource blocks applied in the first system bandwidth may be signalled to at least the first type of mobile terminals, and possibly also to the second type of mobile terminals, while the resource blocks applied in the second system bandwidth need only to be signalled to the second type of mobile terminals. The first type of mobile terminals may comprise legacy mobile terminals and low cost mobile terminals capable of communicating across the first system bandwidth which may be relatively narrow, while the second type of mobile terminals may comprise more advanced mobile terminals capable of communicating across the second system bandwidth which may be relatively wide as well as the first system bandwidth.

In another possible embodiment, the resource blocks applied in the second system bandwidth may be signalled as a delta value indicating a difference between the number of resource blocks in the second system bandwidth and the number of resource blocks in the first system bandwidth. If the number of resource blocks in the first system bandwidth is known to a mobile terminal, e.g. from signalling or preconfiguring of the terminal, the number of resource blocks in the second system bandwidth can be determined by the mobile terminal by adding or subtracting the difference to or from the number of resource blocks in the first system bandwidth depending on the sizes of the first and second system bandwidths. Thus, if the second system bandwidth is wider than the first system bandwidth, the difference is added to the number of resource blocks in the first system bandwidth, and if the second system bandwidth is narrower than the first system bandwidth, the difference is subtracted from the number of resource blocks in the first system bandwidth. Since either an even or odd number of resource blocks is applied for both system bandwidths, the delta value is always an even value. Thereby, the number of bits needed to signal the number of resource blocks in the second system bandwidth can be limited. Alternatively, the number of resource blocks in the second system bandwidth could be signalled as an absolute value and a terminal that receives such an absolute value will just use this value for the second system bandwidth.

In another possible embodiment, the number of bits needed for signalling the above-described delta value may further be dependent on the number of possible even values between the number of resource blocks in the first system bandwidth and the number of resource blocks in the next greater system bandwidth in the set of predefined system bandwidths. The actual bit representation in the signalling for the delta value can exploit this property to reduce the needed number of bits. For example, if the first system bandwidth is 3 MHz containing 15 resource blocks, there are only four possible delta values to define a possible number of resource blocks in the second system bandwidth: delta value=2, 4, 6, and 8 when the second system bandwidth contains 17, 19, 21 and 23 resource blocks, respectively. Hence, only two bits are needed to signal the delta value when the first system bandwidth contains 15 resource blocks.

Some examples of numbers of bits needed for signalling the delta value are shown in Table 2 below, assuming that the set of predefined system bandwidths of Table 1 are valid.

TABLE 2

| Number of resource | |
|---|---|
| blocks in 2^{nd} System | Number of needed bits for |
| Bandwidth | signalling |
| 8-14 | 2 |
| 17-23 | 2 |
| 27-49 | 4 |
| 52-74 | 4 |
| 77-99 | 4 |
| >100 | 3 |

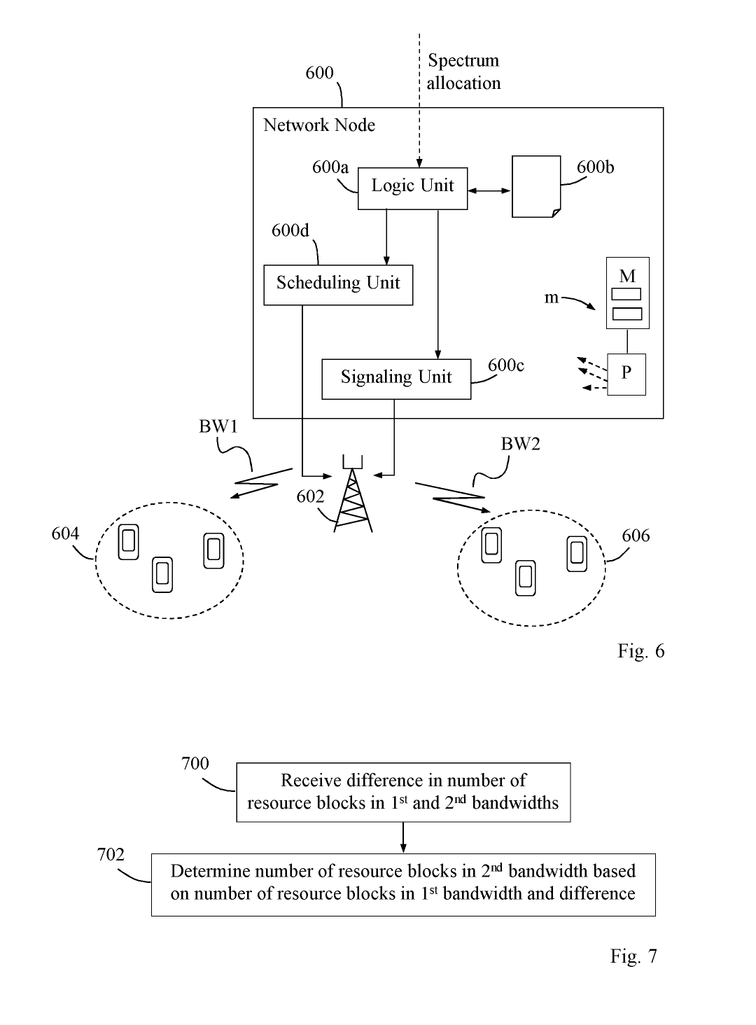

A detailed but non-limiting example of how a network node of a cellular network for radio communication may be structured with some possible functional units to bring about the above-described operation of the network node, is illustrated by the block diagram in FIG. 6. In this figure, the network node 600 is configured to provide radio resources in resource blocks in frequency domain in a first system bandwidth BW1 and in a second system bandwidth BW2 different than the first system bandwidth and overlapping the first system bandwidth. It is assumed that the first and second system bandwidths have a common frequency centre, the radio resources being useful for radio communication with mobile terminals 604, 606 located in a cell or coverage area of the cellular network. The network node 600 may be configured to operate according to any of the examples and embodiments described above and as follows. The network node 600 will now be described in terms of some possible examples of employing the solution.

It is further assumed that a certain frequency spectrum has been allocated to the cellular network, which information may be supplied to and used by the network node as indicated by a dashed arrow. The network node 600 comprises a logic unit 600a which is adapted to apply a number of resource blocks in the first system bandwidth. The logic unit 600a is further adapted to apply an even number of resource blocks in the second system bandwidth when the number of resource blocks in the first system bandwidth is even. By doing this, overlapping resource blocks in the first and second system bandwidths are aligned in the frequency domain. The logic unit 600a is also adapted to apply an odd number of resource blocks in the second system bandwidth when the number of resource blocks in the first system bandwidth is odd. Thereby, overlapping resource blocks in the first and second system bandwidths are aligned in the frequency domain in this case as well.

The network node 600 also comprises a signalling unit 600c which is adapted to signal an indication of the applied number of resource blocks in at least one of the first and second system bandwidths to at least one mobile terminal in the cell or coverage area. The above network node 600 and its functional units may be configured or adapted to operate according to various optional embodiments. In a possible embodiment, the network node 600 further comprises a scheduling unit 600d which may be adapted to schedule the resource blocks in the first system bandwidth to serve a first type of mobile terminals 604 supporting the first system bandwidth but not the second system bandwidth and a second type of mobile terminals 606 supporting the first system bandwidth and the second system bandwidth. The scheduling unit 600d may also be adapted to schedule the resource blocks in the second system bandwidth to serve the second type of mobile terminals 606.

In another possible embodiment, the signalling unit 600c may be adapted to signal the resource blocks applied in the first system bandwidth to at least the first type of mobile terminals and to signal the resource blocks applied in the second system bandwidth to the second type of mobile terminals. The signalling unit 600c may further be adapted to signal the resource blocks applied in the second system bandwidth as a delta value indicating a difference between the number of resource blocks in the second system bandwidth and the number of resource blocks in the first system bandwidth, wherein the delta value is an even value.

In another possible embodiment, the logic unit 600a may be adapted to apply the widest possible system bandwidth in the set of predefined system bandwidths that is within a frequency spectrum allocated for the cellular network as the first system bandwidth, and the second system bandwidth is between the first system bandwidth and the next wider system bandwidth in the set of predefined system bandwidths. Further, the signalling unit 600c may be adapted to signal the indication of the number of resource blocks to multiple mobile terminals in broadcasted system information, or to an individual mobile terminal in a dedicated message.

It should be noted that FIG. 6 illustrates various functional units in the network node 600 and the skilled person is able to implement these functional units in practice using suitable software and hardware. Thus, the solution is generally not limited to the shown structures of the network node 600, and the functional units 600a-d may be configured to operate according to any of the features described in this disclosure, where appropriate.

The functional units 600a-d described above may be implemented in the network node 600 by means of program modules of a respective computer program comprising code means which, when run by a processor “P” causes the network node 600 to perform the above-described actions and procedures. The processor P may comprise a single Central Processing Unit (CPU), or could comprise two or more processing units. For example, the processor P may include a general purpose microprocessor, an instruction set processor and/or related chips sets and/or a special purpose microprocessor such as an Application Specific Integrated Circuit (ASIC). The processor P may also comprise a storage for caching purposes.

Each computer program may be carried by a computer program product in the network node 600 in the form of a memory “M” having a computer readable medium and being connected to the processor P. The computer program product or memory M thus comprises a computer readable medium on which the computer program is stored e.g. in the form of computer program modules “m”. For example, the memory M may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the network node 600.

It was mentioned above that the signalled indication may comprise a difference in number of resource blocks in the first and second system bandwidths. An example of how a mobile terminal may act when receiving such an indication, will now be described with reference to the flow chart in FIG. 7. It is assumed that these actions are performed when the mobile terminal is connected to a serving radio node of a cellular network employing a first system bandwidth and a second system bandwidth for radio communication. It is also assumed that the second system bandwidth is different than the first system bandwidth and overlaps the first system bandwidth, and that the first and second system bandwidths have a common frequency centre.

In a first shown action 700, the mobile terminal receives from the serving radio node a signalled difference between the number of resource blocks in the second system bandwidth and the number of resource blocks in the first system bandwidth. The signalled difference is received as an even delta value such that both numbers of resource blocks in the first and second system bandwidths are even or odd. In a next action 702, the mobile terminal determines the number of resource blocks in the second system bandwidth based on the number of resource blocks in the first system bandwidth and the signalled difference, which may be done in the manner described above in the context of FIG. 5. In this action, the number of resource blocks in the first system bandwidth is somehow known to the mobile terminal, e.g. from signalling or preconfiguring of the terminal.

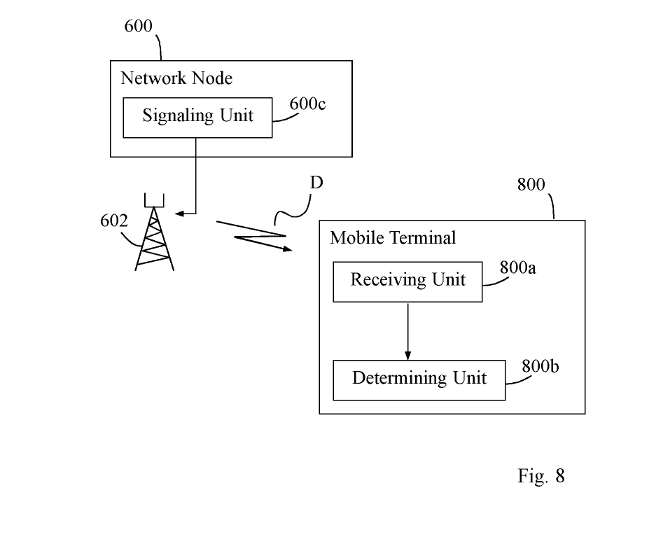

An example of how the mobile terminal may be structured with some possible functional units to bring about the above-described operation of the mobile terminal, is illustrated by the block diagram in FIG. 8. Corresponding numerals are reused from FIG. 6. In this figure, the mobile terminal 800 is adapted to be connected to a serving radio node 602 of a cellular network employing a first system bandwidth and a second system bandwidth for radio communication, wherein the second system bandwidth is different than the first system bandwidth and overlaps the first system bandwidth, the first and second system bandwidths having a common frequency centre. The mobile terminal 800 is also adapted to communicate over radio resources in resource blocks in frequency domain in the second system bandwidth. It is assumed that a network node 600 is connected to the serving radio node 602 and is acting according to any of the examples described above. The mobile terminal 800 will now be described in terms of some possible examples of employing the solution.

The mobile terminal 800 comprises a receiving unit 800a which is adapted to receive from the serving radio node 602 a signalled difference “D” between the number of resource blocks in the second system bandwidth and the number of resource blocks in the first system bandwidth. The receiving unit 800a is further adapted to receive the signalled difference as an even delta value such that both numbers of resource blocks in the first and second system bandwidths are even or odd. The mobile terminal 800 also comprises a determining unit 800b adapted to determine the number of resource blocks in the second system bandwidth based on the number of resource blocks in the first system bandwidth and the signalled difference, e.g. in the manner described above for action 702.

While the solution has been described with reference to specific exemplary embodiments, the description is generally only intended to illustrate the inventive concept and should not be taken as limiting the scope of the solution. For example, the terms “radio node”, “network node”, “mobile terminal” and “resource blocks” have been used throughout this description, although any other corresponding entities, functions, and/or parameters could also be used having the features and characteristics described here. The solution is defined by the appended claims.

1-20. (canceled)

21. A method performed by a network node of a cellular network for radio communication, for providing radio resources in resource blocks in the frequency domain in a first system bandwidth and in a second system bandwidth, wherein the second system bandwidth is different than the first system bandwidth and overlaps the first system bandwidth, wherein the first and second system bandwidths have a common frequency center and the radio resources are used for radio communication with mobile terminals in a cell or coverage area of the cellular network, the method comprising:
applying a number of resource blocks in the first system bandwidth;
applying an even number of resource blocks in the second system bandwidth, when the number of resource blocks in the first system bandwidth is even;
applying an odd number of resource blocks in the second system bandwidth, when the number of resource blocks in the first system bandwidth is odd; and
signaling an indication of the applied number of resource blocks in at least one of the first and second system bandwidths, to at least one mobile terminal in the cell or coverage area.

22. The method according to claim 21, wherein the indication comprises any of: the applied number of resource blocks in at least one of the first and second system bandwidths, identities of the resource blocks in at least one of the first and second system bandwidths, and a difference in number of resource blocks in the first and second system bandwidths.

23. The method according to claim 21, wherein the resource blocks in the first system bandwidth are scheduled to serve a first type of mobile terminals supporting the first system bandwidth but not the second system bandwidth and a second type of mobile terminals supporting the first system bandwidth and the second system bandwidth, and wherein the resource blocks in the second system bandwidth are scheduled to serve the second type of mobile terminals.

24. The method according to claim 23, wherein an indication of the resource blocks applied in the first system bandwidth is signaled to at least the first type of mobile terminals, and an indication of the resource blocks applied in the second system bandwidth is signaled to the second type of mobile terminals.

25. The method according to claim 21, wherein the resource blocks applied in the second system bandwidth are indicated by signaling a delta value indicating a difference between the number of resource blocks in the second system bandwidth and the number of resource blocks in the first system bandwidth, wherein the delta value is an even value.

26. The method according to claim 25, wherein the number of bits needed for signaling the delta value is dependent on the number of possible even values between the number of resource blocks in the first system bandwidth and the number of resource blocks in the next greater system bandwidth in the set of predefined system bandwidths.

27. The method according to claim 21, wherein the number of resource blocks in the first system bandwidth is selected out of a set of predefined numbers of resource blocks valid for a set of predefined system bandwidths.

28. The method according to claim 27, wherein the widest possible system bandwidth in the set of predefined system bandwidths that is within a frequency spectrum allocated for the cellular network is applied as the first system bandwidth, and the second system bandwidth is between the first system bandwidth and the next wider system bandwidth in the set of predefined system bandwidths.

29. The method according to claim 21, wherein the indication of the number of resource blocks is signaled to multiple mobile terminals in broadcasted system information, or to an individual mobile terminal in a dedicated message.

30. A network node configured for operation in a cellular network for radio communication, the network node being configured to provide radio resources in resource blocks in the frequency domain in a first system bandwidth and in a second system bandwidth, wherein the second system bandwidth is different than the first system bandwidth and overlaps the first system bandwidth, wherein the first and second system bandwidths have a common frequency center and the radio resources are used for radio communication with mobile terminals in a cell or coverage area of the cellular network, and wherein the network node comprises:
a processing circuit configured to:
apply a number of resource blocks in the first system bandwidth;
apply an even number of resource blocks in the second system bandwidth, when the number of resource blocks in the first system bandwidth is even; and
apply an odd number of resource blocks in the second system bandwidth, when the number of resource blocks in the first system bandwidth is odd; and
a signaling circuit configured to signal an indication of the applied number of resource blocks in at least one of the first and second system bandwidths, to at least one mobile terminal in the cell or coverage area.

31. The network node according to claim 30, wherein the indication comprises any of: the applied number of resource blocks in at least one of the first and second system bandwidths, identities of the resource blocks in at least one of the first and second system bandwidths, and a difference in number of resource blocks in the first and second system bandwidths.

32. The network node according to claim 30, wherein the processing circuit is configured to schedule the resource blocks in the first system bandwidth to serve a first type of mobile terminals supporting the first system bandwidth but not the second system bandwidth and a second type of mobile terminals supporting the first system bandwidth and the second system bandwidth, and to schedule the resource blocks in the second system bandwidth to serve the second type of mobile terminals.

33. The network node according to claim 32, wherein the processing circuit is configured to indicate, via signaling to at least the first type of mobile terminals, the resource blocks applied in the first system bandwidth, and to indicate, via signaling to the second type of mobile terminals, the resource blocks applied in the second system bandwidth.

34. The network node according to claim 30, wherein the processing circuit is configured to indicate the resource blocks applied in the second system bandwidth, based on signaling a delta value indicating a difference between the number of resource blocks in the second system bandwidth and the number of resource blocks in the first system bandwidth, wherein the delta value is an even value.

35. The network node according to claim 34, wherein the number of bits needed for signaling the delta value is dependent on the number of possible even values between the number of resource blocks in the first system bandwidth and the number of resource blocks in the next greater system bandwidth in the set of predefined system bandwidths.

36. The network node according to claim 30, wherein the number of resource blocks in the first system bandwidth is selected out of a set of predefined numbers of resource blocks valid for a set of predefined system bandwidths.

37. The network node according to claim 36, wherein the processing circuit is configured to apply the widest possible system bandwidth in the set of predefined system bandwidths that is within a frequency spectrum allocated for the cellular network as the first system bandwidth, and the second system bandwidth is between the first system bandwidth and the next wider system bandwidth in the set of predefined system bandwidths.

38. The network node according to claim 30, wherein the processing circuit is configured to signal the indication of the number of resource blocks to multiple mobile terminals in broadcasted system information, or to an individual mobile terminal in a dedicated message.

39. A method performed by a mobile terminal connected to a serving radio node of a cellular network employing a first system bandwidth and a second system bandwidth for radio communication, wherein the second system bandwidth is different than the first system bandwidth and overlaps the first system bandwidth and the first and second system bandwidths have a common frequency center, and wherein the method comprises:
receiving from the serving radio node a signaled difference between the number of resource blocks in the second system bandwidth and the number of resource blocks in the first system bandwidth, wherein the signaled difference is received as an even delta value, such that both numbers of resource blocks in the first and second system bandwidths are even or odd; and
determining the number of resource blocks in the second system bandwidth, based on the number of resource blocks in the first system bandwidth and the signaled difference.

40. A mobile terminal configured to be connected to a serving radio node of a cellular network employing a first system bandwidth and a second system bandwidth for radio communication, wherein the second system bandwidth is different than the first system bandwidth and overlaps the first system bandwidth and the first and second system bandwidths have a common frequency center, and wherein the mobile terminal comprises:
a receiver circuit configured to receive from the serving radio node a signaled difference between the number of resource blocks in the second system bandwidth and the number of resource blocks in the first system bandwidth, the signaled difference being received as an even delta value, such that both numbers of resource blocks in the first and second system bandwidths are even or odd; and
a processing circuit configured to determine the number of resource blocks in the second system bandwidth, based on the number of resource blocks in the first system bandwidth and the signaled difference.
